(19) United States
(12) Patent Application Publication
(10) Pub. No.: US 2026/0085739 A1
(43) Pub. Date: Mar. 26, 2026

(54) DAMPER LIMITING SYSTEM

(71) Applicants: Thyssenkrupp Bilstein of America Inc., Hamilton, OH (US); thyssenkrupp AG, Essen (DE)

(72) Inventors: Peter KROPCZYNSKI, Cincinnati, OH (US); Jayson MOORE, Cincinnati, OH (US); Eric SOROSIAK, Liberty Township, OH (US)

(73) Assignees: Thyssenkrupp Bilstein of America Inc., Hamilton, OH (US); thyssenkrupp AG, Essen (DE)

(21) Appl. No.: 18/892,163

(22) Filed: Sep. 20, 2024

(51) Int. Cl. F16F 9/49; F16F 9/06; F16F 9/19; F16F 9/32; F16F 9/516

(52) U.S. Cl. CPC F16F 9/49; F16F 9/19; F16F 9/3235; F16F 9/3271; F16F 9/516; F16F 9/065; F16F 2226/04; F16F 2228/066; F16F 2230/02; F16F 2230/18; F16F 2230/42

(57) ABSTRACT

A hydraulic vibration damper comprises a damper tube having a hollow main body, a first end, and a second end opposite to the first end, a piston rod that extends into the damper tube through the second end of the damper tube, a primary piston mounted on the piston rod inside the damper tube, a secondary piston mounted on the piston rod inside the damper tube, and a two-stage jounce cut off assembly mounted directly to, and in direct contact with, an inner surface of the hollow main body of the damper tube, wherein the jounce cut off assembly is located between the first end of the damper tube and the secondary piston, and wherein the jounce cut off assembly is configured to increase a hydraulic resistance to movement of the piston rod through the damper tube when the secondary piston engages the jounce cut off assembly.

### FIELD

The present disclosure generally relates to hydraulic vibration dampers and more particularly to hydraulic vibration dampers that incorporate a hydraulic compression or jounce cut off assembly that provides end stop control and an increased damping force at specific location(s).

### BACKGROUND

Hydraulic vibration dampers are used in vehicles to dissipate vibration energy caused by the vehicle travelling over uneven road surfaces. Generally, vibration dampers can include a damper tube and a working piston guided in the damper tube along a longitudinal axis. A piston rod leading out of the damper tube can be arranged on the working piston and, by way of the piston rod, the working piston can be displaced in the damper tube. The piston rod is caused to traverse within the damper tube in an extension direction (that is, outward relative to the damper tube, referred to herein as “rebound”) and a compression or retraction direction (that is, inward relative to the damper tube, referred to herein as “jounce”) during a damping event. In general, the piston rod can be limited in the extension direction at a fully extended position and in the compression, jounce, or retraction direction at a fully compressed position. In examples, it can be desirable to mitigate the forces seen on the vibration damper before reaching either the fully extended position or the fully compressed position, such as by increasing damping forces prior to the damper bottoming out. For example, at full compression, undesirable noise, vibration and harshness (NVH) characteristics, as well as undesirable effects to performance and comfort, can result due to any abrupt contact of features within the vibration damper at, or near, full compression. Accordingly, while conventional hydraulic vibration dampers work well for their intended purpose, there exists an opportunity for improvement in the relevant art.

### SUMMARY

A hydraulic vibration damper may be summarized as comprising: a damper tube having a hollow main body, a first end, and a second end opposite the first end; a piston rod that extends into the damper tube through the second end of the damper tube; a primary piston mounted on the piston rod inside the damper tube; a secondary piston inside the damper tube; and a two-stage jounce cut off assembly mounted inside the damper tube between the first end of the damper tube and the secondary piston; wherein the two-stage jounce cut off assembly is configured such that, in a first stage of operation, fluid flows from a first reservoir through the secondary piston and, in a second stage of operation, fluid flows from a second reservoir through the secondary piston; wherein a diameter of the first reservoir is less than an inner diameter of the hollow main body of the damper tube and a diameter of the second reservoir is equal to the inner diameter of the hollow main body of the damper tube.

The secondary piston may be configured such that hydraulic fluid can flow through the secondary piston during jounce but not during rebound. The secondary piston may be configured such that hydraulic fluid can flow through the secondary piston during jounce and during rebound. The two-stage jounce cut off assembly may include: an inner tube mounted within the damper tube, wherein in the second stage of operation of the two-stage jounce cut off assembly, the inner tube is configured to translate longitudinally with respect to the damper tube; and a catch ring mounted within the inner tube, wherein in the first stage of operation of the two-stage jounce cut off assembly, the catch ring is configured to translate longitudinally with respect to the inner tube.

The hydraulic vibration damper may further comprise: a circumferential groove extending around the inner surface of the damper tube; and a snap ring seated within the groove; wherein the two-stage jounce cut off assembly is mounted directly to, and in direct contact with, the inner surface of the hollow main body of the damper tube at least by the snap ring. The hydraulic vibration damper may further comprise: a circumferential ridge extending around the inner surface of the damper tube; wherein the jounce cut off assembly is mounted directly to, and in direct contact with, the inner surface of the hollow main body of the damper tube at least by the circumferential ridge.

A hydraulic vibration damper may be summarized as comprising: a damper tube having a hollow main body, a first end, and a second end opposite to the first end; a piston rod that extends into the damper tube through the second end of the damper tube; a primary piston mounted on the piston rod inside the damper tube; a secondary piston inside the damper tube; and a two-stage jounce cut off assembly mounted directly to, and in direct contact with, an inner surface of the hollow main body of the damper tube; wherein the jounce cut off assembly is located between the first end of the damper tube and the secondary piston; wherein the jounce cut off assembly is configured to increase a hydraulic resistance to movement of the piston rod through the damper tube when the secondary piston engages the jounce cut off assembly.

The secondary piston may be configured such that hydraulic fluid can flow through the secondary piston during jounce but not during rebound. The secondary piston may be configured such that hydraulic fluid can flow through the secondary piston during jounce and during rebound. The two-stage jounce cut off assembly may include: an inner tube mounted within the damper tube, wherein in a second stage of operation of the two-stage jounce cut off assembly, the inner tube is configured to translate longitudinally with respect to the damper tube; and a catch ring mounted within the inner tube, wherein in a first stage of operation of the two-stage jounce cut off assembly, the catch ring is configured to translate longitudinally with respect to the inner tube.

The hydraulic vibration damper may further comprise: a circumferential groove extending around the inner surface of the damper tube; and a snap ring seated within the groove; wherein the two-stage jounce cut off assembly is mounted directly to, and in direct contact with, the inner surface of the hollow main body of the damper tube at least by the snap ring. The hydraulic vibration damper may further comprise: a circumferential ridge extending around the inner surface of the damper tube; wherein the jounce cut off assembly is mounted directly to, and in direct contact with, the inner surface of the hollow main body of the damper tube at least by the circumferential ridge.

An outer surface of the two-stage jounce cut off assembly may be directly physically sealed against an inner surface of the hollow main body of the damper tube. The outer surface of the two-stage jounce cut off assembly may be configured to translate along the inner surface of the hollow main body of the damper tube. The two-stage jounce cut off assembly may be configured such that, in a first stage of operation, fluid flows from a first reservoir through the secondary piston and, in a second stage of operation, fluid flows from a second reservoir through the secondary piston; wherein a diameter of the first reservoir is less than an inner diameter of the hollow main body of the damper tube and a diameter of the second reservoir is equal to the inner diameter of the hollow main body of the damper tube.

A method of manufacturing a hydraulic vibration damper may be summarized as comprising: fabricating a damper tube having a hollow main body, a first end, and a second end opposite to the first end; assembling a two-stage jounce cut off assembly outside the damper tube; inserting the assembled two-stage jounce cut off assembly as a unit into the damper tube; mounting the two-stage jounce cut off assembly directly to, and in direct contact with, an inner surface of the hollow main body of the damper tube; and crimping the hollow main body of the damper tube to secure the two-stage jounce cut off assembly inside the damper tube.

The two-stage jounce cut off assembly may be configured such that, in a first stage of operation, fluid flows from a first reservoir through a piston and, in a second stage of operation, fluid flows from a second reservoir through the piston; and a diameter of the first reservoir may be less than an inner diameter of the hollow main body of the damper tube and a diameter of the second reservoir may be equal to the inner diameter of the hollow main body of the damper tube. Assembling a two-stage jounce cut off assembly outside the damper tube may include inserting a catch ring into an inner tube and mounting a spacer on an exterior of the inner tube. Assembling the two-stage jounce cut off assembly outside the damper tube may further include crimping a first end of the inner tube onto the first cap and crimping a second end of the inner tube onto the second cap, thereby locking the catch ring within the inner tube and the spacer on the exterior of the inner tube.

Further areas of applicability of the teachings of the present disclosure will become apparent from the detailed description, claims, and the drawings, wherein like reference numerals refer to like features throughout the several views of the drawings. It should be understood that the detailed description, including disclosed embodiments and drawings referenced therein, are intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 illustrates an embodiment of a hydraulic vibration damper system with a two-stage jounce cut off assembly in an unengaged and uncompressed configuration as a piston rod begins to retract (that is, move inward relative to the damper tube or downward in FIG. 1).

FIG. 2 illustrates some of the components illustrated in FIG. 1 at a larger scale.

FIG. 3 illustrates the components of FIG. 2 as a first stage of the two-stage jounce cut off assembly is initially engaged.

FIG. 4 illustrates the components of FIGS. 2 and 3 as a first stage of the two-stage jounce cut off assembly is partially compressed.

FIG. 5 illustrates the components of FIGS. 2-4 as a first stage of the two-stage jounce cut off assembly is fully compressed and as a second stage of the two-stage jounce cut off assembly is initially engaged.

FIG. 6 illustrates the components of FIGS. 2-5 with the first stage of the two-stage jounce cut off assembly fully compressed and a second stage of the two-stage jounce cut off assembly partially compressed.

FIG. 7 illustrates the components of FIGS. 2-6 with the first stage of the two-stage jounce cut off assembly fully compressed and a second stage of the two-stage jounce cut off assembly fully compressed.

FIG. 8 illustrates the components of FIGS. 2-7 with the first stage of the two-stage jounce cut off assembly fully compressed and the second stage of the two-stage jounce cut off assembly fully compressed as a piston rod begins to extend or rebound (that is, move outward relative to the damper tube or upward in FIG. 8) and disengage from the two-stage jounce cut off assembly.

FIG. 9 illustrates another embodiment of a hydraulic vibration damper system with a two-stage jounce cut off assembly in an unengaged and uncompressed configuration as a piston rod begins to retract (that is, move inward relative to the damper tube or downward in FIG. 9), where the two stage jounce cut off assembly has been secured in position by crimping.

FIG. 10 illustrates another embodiment of a hydraulic vibration damper system with a two-stage jounce cut off assembly in an unengaged and uncompressed configuration as a piston rod begins to retract (that is, move inward relative to the damper tube or downward in FIG. 10), where a secondary piston is configured for bi-directional fluid flow.

### DETAILED DESCRIPTION

In hydraulic vibration dampers, the piston rod can be limited in the extension direction at a fully extended position and in the compression, jounce, or retraction direction at a fully retracted or fully compressed position. In examples, it can be desirable to increase the forces seen on the vibration damper and the damping effect provided by the damper before reaching the fully compressed position, such as to reduce an amount of energy that goes into and is dissipated in a hard stop impact and thereby reduce or avoid harsh impacts experienced within the vibration damper at, or near, full compression. As explained in greater detail herein, the present disclosure provides hydraulic vibration dampers having hydraulic jounce end stop control to improve comfort and control of a vehicle.

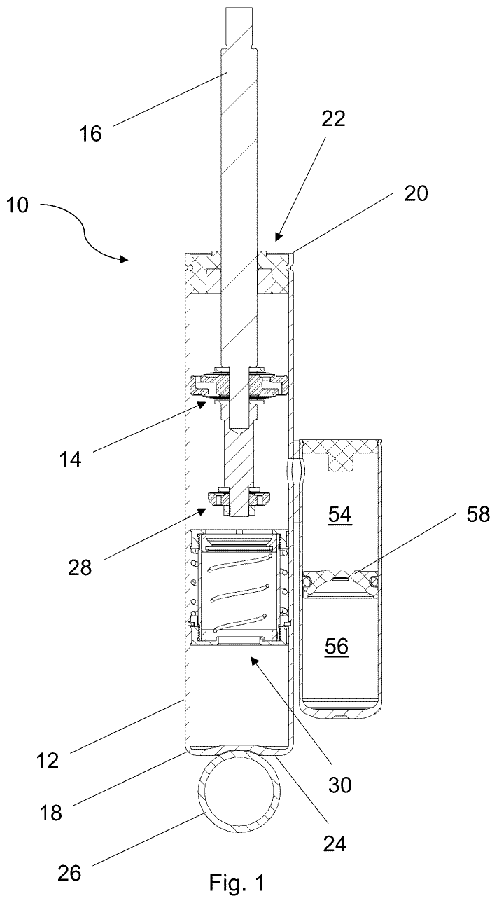

FIG. 1 illustrates a hydraulic vibration damper system 10. FIG. 1 illustrates that the system 10 includes an outer piston tube 12, which may also be referred to herein as a damper tube 12, as well as a primary piston 14 mounted on a piston rod 16. The damper tube 12 is filled with a hydraulic fluid and the primary piston 14 includes valves and a variety of features through which the hydraulic fluid can flow as the primary piston 14 moves inward and outward relative to the damper tube 12. FIG. 1 also illustrates that the hydraulic vibration damper system 10 includes a remote hydraulic reservoir 54 hydraulically coupled to the damper tube 12 such that the hydraulic fluid can flow between the damper tube 12 and the remote hydraulic reservoir 54. FIG. 1 also illustrates that the hydraulic vibration damper system 10 includes a gas reservoir 56 filled with a gas such as air or nitrogen gas (N2), as well as a dividing piston 58 that separates the remote hydraulic reservoir 54 from the gas reservoir 56.

During ordinary operation of the system 10, longitudinal movements and/or vibrations of the piston rod 16 and the primary piston 14 within and relative to the damper tube 12 are damped by flow of the hydraulic fluid through the primary piston 14 and its valves and other related features. In particular, such flow is highly controlled such that viscosity, friction, and/or other effects provide resistance to movement of the piston rod 16 relative to the damper tube 12 and convert kinetic energy of the piston rod 16 into heat in the hydraulic fluid, which is then dissipated to the environment through the damper tube 12. In some embodiments, the damper tube 12 is the only layer of material separating the hydraulic fluid from the environment surrounding the damper system 10 and the damper tube 12 is made of a highly heat-conductive material such that heat can be dissipated relatively quickly from the hydraulic fluid to the environment.

As illustrated in FIG. 1, the damper tube 12 is a single solid, monolithic and integral component made from a consistent material and includes a generally cylindrical main body and a generally circular end portion or cap 24 that is monolithic or integral with the generally cylindrical main body to form a closed first end 18, which may be referred to as a compression end 18 of the damper tube 12. In some alternative embodiments, the damper tube 12 may include a generally cylindrical main body and a generally circular end portion or cap 24 that are formed from separate components. The damper tube 12 has an open second end 20, which may be referred to as an extension end 20 of the damper tube 12, which may be opposite to the closed first end 18, and which can be closed and sealed by an additional separate cap assembly 22 that may include, for example, gaskets, seals, etc., and which is not monolithic or integral with the generally cylindrical main body of the damper tube 12.

As illustrated, the piston rod 16 extends from a first end thereof outside of the damper tube 12, through the cap assembly 22, to a second end thereof opposite to the first end thereof inside the damper tube 12. That the damper tube 12 includes the closed first end 18 stands in contrast to some other damper tubes, which do not include integral end portions but instead are sealed at both ends by additional cap assemblies including gaskets, seals, etc., that are not formed monolithically or integrally with the generally cylindrical main body of the damper tube 12. Providing the damper tube 12 with an integral end portion 24 as in the embodiments described herein can provide distinct advantages, at least in terms of costs and/or reliability.

In FIG. 1, the closed first end 18 of the damper tube 12 is illustrated as oriented at the bottom of the system 10 and the open second end 20 of the damper tube 12 is illustrated as oriented at the top of the system 10. In practice, when the system 10 is in use, it may be installed on a vehicle in the illustrated orientation, such that the open second end 20 is above the closed first end 18, such as when the system includes both hydraulic fluid and gases, such that the gases rise to desired location(s) above the hydraulic fluid. In general, however, it is also possible in some embodiments that when the system 10 is in use, it may be installed on a vehicle opposite to the illustrated orientation, such that the open second end 20 is below the closed first end 18.

As illustrated in FIG. 1, the closed first end 18 of the damper tube 12 is directly coupled to (e.g., welded to) a mounting component, such as a mounting ring 26. In practice, when the system 10 is in use, it may be installed on a vehicle by coupling a first component of the vehicle, such as a component of a wheel suspension system or a body, frame, or chassis thereof, to the mounting ring 26, as well as by coupling a second component of the vehicle, such as a component of a wheel suspension system or a body, frame, or chassis thereof, to a terminal end portion of the piston rod 16 that is opposite to the closed first end 18 of the damper tube 12 and that extends out of and is exposed outside of the damper tube 12. Thus, one end of the system 10 can be coupled to a wheel of the vehicle (for example, via a mechanical upright component) and the other, opposite end of the system 10 can be coupled to a chassis of the vehicle, such that the system 10 can damp movement and/or vibration of the wheels of the vehicle relative to the chassis of the vehicle and thereby provide a relatively smooth ride for passengers in the vehicle as the vehicle traverses uneven terrain.

FIG. 1 illustrates the system 10 in an unengaged and uncompressed configuration as the piston rod 16 begins to retract in a jounce movement or jounce phase of operation of the system 10 (that is, move inward relative to the damper tube 12 or downward as illustrated in FIG. 1). As illustrated in FIG. 1, in addition to the primary piston 14 mounted on the piston rod 16, the system 10 also includes a secondary piston 28 mounted on the piston rod 16 and spaced longitudinally apart from the primary piston 14 along the length of the piston rod 16 such that the secondary piston 28 is proximate an inner end of the piston rod 16 and such that the primary piston 14 is between the secondary piston 28 and the open second end 20 of the damper tube 12.

The secondary piston 28 includes valves and a variety of features, which may be similar to those of the primary piston 14, through which the hydraulic fluid can flow under appropriate circumstances (e.g., when the secondary piston 28 engages a jounce cut off assembly) and as the secondary piston 28 moves, especially inward relative to the damper tube 12. Whereas the primary piston 14 has an outer diameter configured such that it engages with an inner surface of the damper tube 12, however, the secondary piston 28 has an outer diameter smaller than that of the primary piston 14 and configured such that it does not engage the inner surface of the damper tube 12 such that, during ordinary operation of the system 10, longitudinal movements and/or vibrations of the piston rod 16 within and relative to the damper tube 12 are not damped by flow of the hydraulic fluid through the secondary piston 28, because the hydraulic fluid can flow around the secondary piston 28 between the outer periphery of the secondary piston 28 and the inner surface of the damper tube 12 without significant resistance.

Nevertheless, when hydraulic fluid does flow through the secondary piston 28, such flow is highly controlled such that viscosity, friction, and/or other effects provide resistance to movement of the piston rod 16 relative to the damper tube 12 and convert kinetic energy of the piston rod 16 into heat in the hydraulic fluid, which is then dissipated to the environment through the damper tube 12. In such cases, the damping effect of the hydraulic fluid flowing through the secondary piston 28 adds to the damping effect of the hydraulic fluid flowing through the primary piston 14.

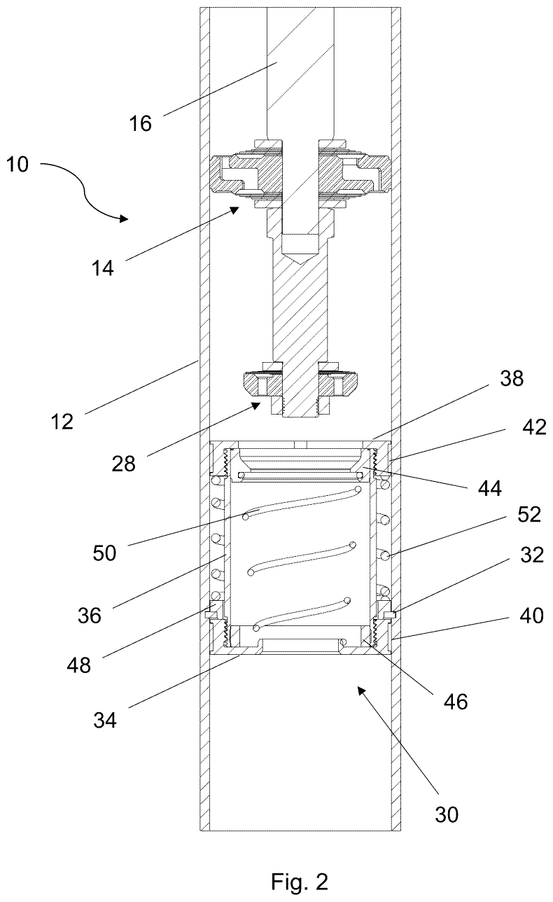

FIG. 2 illustrates some of the components of the system 10 at a larger scale than in FIG. 1. FIG. 2 illustrates that the system includes a two-stage jounce cut off assembly 30 located between the closed first end 18 of the damper tube 12 and the piston rod 16 and the secondary piston 28 it carries. FIG. 2 illustrates the assembly 30 in an unengaged and uncompressed configuration as the piston rod 16 begins to retract within the damper tube 12 (that is, move inward relative to the damper tube 12 or downward in FIG. 2). In the configuration illustrated in FIG. 2, therefore, hydraulic fluid flows around an outer periphery of the secondary piston 28 rather than through the secondary piston 28 as the secondary piston 28 moves longitudinally through the damper tube 12.

As illustrated in FIG. 2, the system 10 includes a single, individual snap ring 32 by which the jounce cut off assembly 30 is mounted to and retained within the damper tube 12. In particular, the damper tube 12 has a single individual circumferential groove cut into its inner surface, and the snap ring 32 is configured and positioned such that approximately a radial outer half thereof is mounted and positioned within the circumferential groove formed in the inner surface of the damper tube 12 and a radial inner half thereof therefore extends radially inward into the generally cylindrical inner chamber formed within the damper tube 12.

As further illustrated in FIG. 2, the jounce cut off assembly 30 includes a first cap 34 located and locked between the closed first end 18 of the damper tube 12 and the snap ring 32 (that is, below the snap ring 32 as illustrated in FIG. 2). Because the first cap 34 is below the snap ring 32 as illustrated in FIG. 2, it may also be referred to as a lower cap 34, and because the first cap 34 is located relatively close to the closed first end 18 of the damper tube 12, it may also be referred to as an inner cap 34. An outer diameter of the first cap 34 is larger than an inner diameter of the snap ring 32 such that the first cap 34 can move between the closed first end 18 of the damper tube 12 and the snap ring 32 but not past the snap ring 32 toward the open second end 20 of the damper tube 12.

As further illustrated in FIG. 2, the jounce cut off assembly 30 includes a second cap 38 located in position between the open second end 20 of the damper tube 12 and the snap ring 32 (that is, above the snap ring 32 as illustrated in FIG. 2). Because the second cap 38 is above the snap ring 32 as illustrated in FIG. 2, it may also be referred to as an upper cap 38, and because the second cap 38 is located relatively far from the closed first end 18 of the damper tube 12, it may also be referred to as an outer cap 38. As further illustrated in FIG. 2, the jounce cut off assembly 30 includes a first, inner seal 40, which may function as a gasket, wear band, and/or wear ring, and that seals an outer surface of the first cap 34 to an inner surface of the damper tube 12 such that hydraulic fluid cannot pass between such components, and a second, outer gasket 42 that seals an outer surface of the second cap 38 to an inner surface of the damper tube 12 such that hydraulic fluid cannot pass between such components.

The jounce cut off assembly 30 further includes an inner tube 36, wherein a first terminal end thereof may be threaded by external threads into counterpart threads formed in an inner surface of the first cap 34 and wherein a second terminal end thereof may be threaded by external threads into counterpart threads formed in an inner surface of the second cap 38. Thus, the first cap 34, the inner tube 36, and the second cap 38 (as well as the gaskets 40 and 42) can be rigidly coupled to one another and move as a unit relative to the damper tube 12. Movement of this unit, including the first cap 34, the inner tube 36, and the second cap 38, can be referred to as the second stage of the two-stage jounce cut off assembly 30 and will be discussed further elsewhere herein.

As illustrated in FIG. 2, the second cap 38 includes a radially inwardly protruding ring, which projects radially inward beyond an inner surface of the inner tube 36, by which a first stage of the two-stage jounce cut off assembly 30 is mounted and retained within inner tube 36, and such that the first stage of the two-stage jounce cut off assembly 30 can but up against the inwardly protruding ring. In particular, as illustrated in FIG. 2, the jounce cut off assembly 30 further includes a catch ring 44 located and locked between the closed first end 18 of the damper tube 12 and the second cap 38 by the inwardly protruding ring of the second cap 38. An outer diameter of the catch ring 44 larger than an inner diameter of the inwardly protruding ring of the second cap 38 such that the catch ring 44 can move away from the second cap 38 toward the closed first end 18 of the damper tube 12 but not past the second cap 38 toward the open second end 20 of the damper tube 12.

A method of assembling the hydraulic vibration damper system 10 may include fabricating the damper tube 12. Such fabrication may include obtaining or otherwise starting with a simple hollow cylinder open and each of its two opposite ends, and then closing a first one of the ends to form the closed first end 18 of the damper tube 12. This can be achieved, for example, by hot or cold working of the tube to manipulate, bend, or otherwise plastically deform the material of the damper tube at its first end to form the closed first end 18 of the damper tube 12, and/or by welding the first end of the damper tube 12 closed. Once this is complete, the closed first end 18 of the damper tube 12 is sealed against the passage of fluids such as liquids including hydraulic fluids and gases including air or nitrogen gas (N2), and the closed first end 18 of the damper tube 12 is formed integrally, monolithically, or in a one-piece or single-piece construction with the rest of the damper tube 12, including its generally cylindrical main body. In some alternative embodiments, the method can include fabricating the first end 18 of the damper tube 12 and the cylindrical main body of the damper tube 12 from separate components. Such fabrication of the damper tube 12 may also include machining or otherwise cutting or forming a circumferential groove that extends around the interior surface of the damper tube 12 that is configured to receive the snap ring 32.

Once the damper tube 12 has been formed, the jounce cut off assembly 30 can be assembled inside the damper tube 12. For example, the first cap 34 can be inserted into the damper tube 12. The snap ring 32 can then be inserted into the damper tube 12 and snapped into and seated within the circumferential groove, thereby locking the first cap 34 inside the damper tube 12. The inner tube 36 can then be inserted into the damper tube 12 and threaded into the first cap 34. The catch ring 44 can then be inserted into the inner tube 36, and the second cap 38 can then be inserted into the damper tube 12 and threaded onto the inner tube 36, thereby locking the catch ring 44 within the inner tube 36 and the damper tube 12. Other components, such as those described elsewhere herein, including the inner gasket 40 and outer gasket 42, may also be inserted into the damper tube 12 and coupled to the various components of the jounce cut off assembly 30. While the jounce cut off assembly 30 can be assembled inside the damper tube 12 as described herein, in other embodiments, the jounce cut off assembly 30 can be assembled as a unit outside the damper tube 12 and then inserted into and installed within the damper tube 12, such as in accordance with description elsewhere herein.

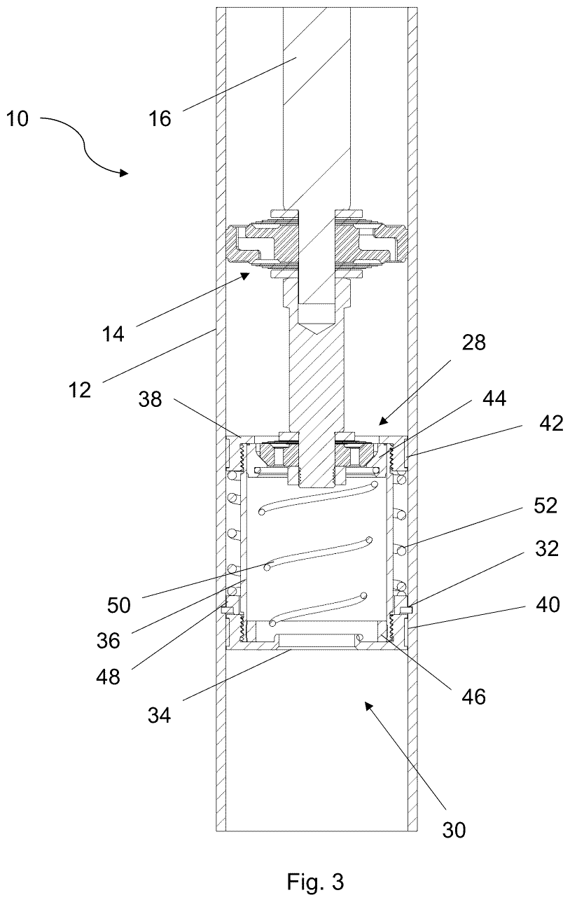

FIG. 3 illustrates the components of FIG. 2 as the secondary piston 28 has moved toward and initially made contact with the jounce cut off assembly 30 such that the secondary piston 28 has made contact with the catch ring 44 and thereby engaged the first stage of the two-stage jounce cut off assembly 30. Once the secondary piston 28 has made contact with the catch ring 44, the hydraulic fluid within the damper tube 12 can no longer flow freely around the secondary piston 28, because a circumferential seal is formed between the secondary piston 28 and the catch ring 44. Thus, the hydraulic fluid is forced to flow through the secondary piston 28, thereby engaging the valving or other features of the secondary piston that provide a damping effect by converting kinetic energy into heat as described elsewhere herein. This damping effect adds to a primary damping effect provided by flow of the hydraulic fluid through the primary piston 14, and can significantly increase overall damping effects of the system 10.

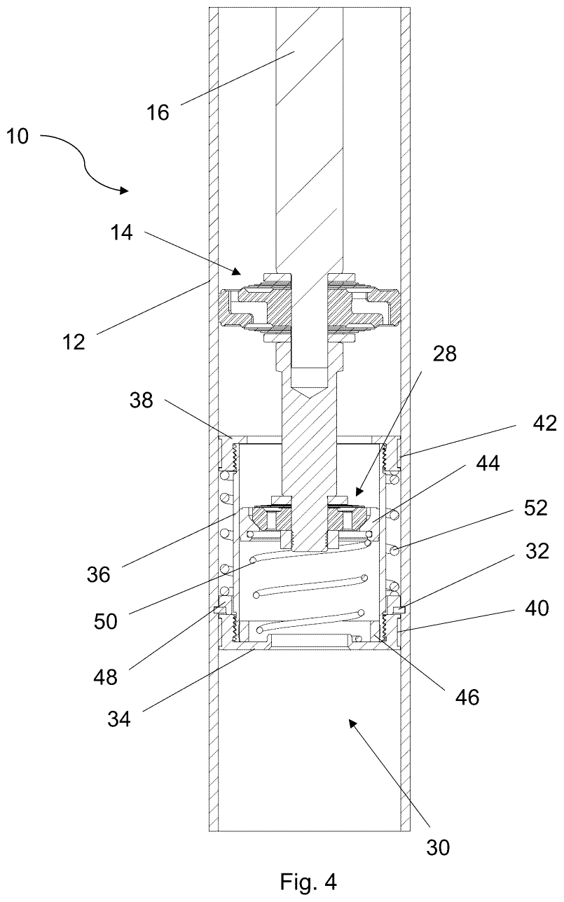

FIG. 4 illustrates the components of FIGS. 2 and 3 as the first stage of the two-stage jounce cut off assembly 30 is partially compressed. In particular, in the configuration shown in FIG. 4, the secondary piston 28 has pushed the catch ring 44 partially along its available travel length from engagement with the second cap 38 toward the first cap 34 and partially along the length of the inner tube 36. Such movement of the catch ring 44 within the inner tube 36 can be referred to as the first stage of the two-stage jounce cut off assembly 30. As the catch ring 44 travels along the length of the inner tube 36, an outer surface of the catch ring 44 engages with and is sealed against an inner surface of the inner tube 36, to prevent hydraulic fluid flowing around the catch ring 44 between the catch ring 44 and the inner tube 36, such that the hydraulic fluid is forced to flow from a first reservoir through the secondary piston 28, thereby providing the damping effects described herein.

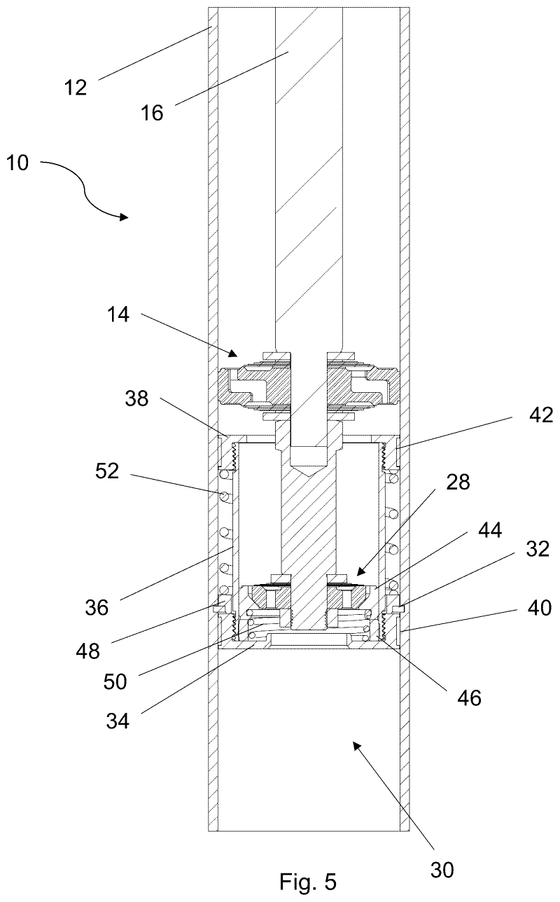

FIG. 5 illustrates the components of FIGS. 2-4 as the first stage of the two-stage jounce cut off assembly 30 is fully compressed. In particular, in the configuration shown in FIG. 5, the secondary piston 28 has pushed the catch ring 44 along its entire available travel length, along the entire length of the inner tube 36, from engagement with the second cap 38 to engagement with an inner, first stage spacer or stopper 46 that prevents the catch ring 44 from directly colliding at the end of its stroke with the first cap 34 (in some embodiments, intermediate components, such as a spring, may be present between the catch ring 44 and the spacer 46 in this configuration). Because the first stage of the two-stage jounce cut off assembly 30 is fully compressed, FIG. 5 also illustrates the assembly 30 at initial engagement of the second stage of the two-stage jounce cut off assembly 30.

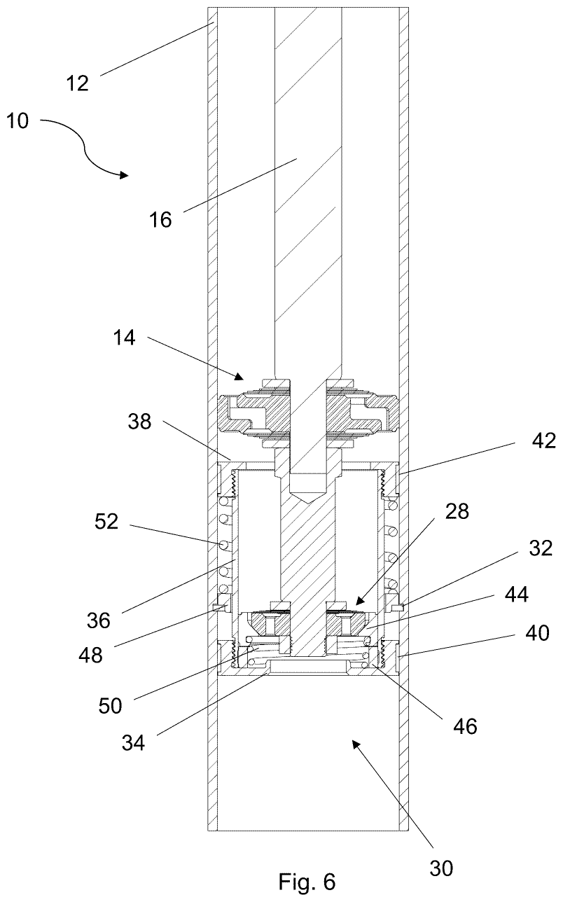

FIG. 6 illustrates the components of FIGS. 2-5 with the first stage of the two-stage jounce cut off assembly 30 fully compressed and the second stage of the two-stage jounce cut off assembly 30 partially compressed. In particular, in the configuration shown in FIG. 6, the secondary piston 28 has pushed the catch ring 44, together with the spacer 46, the first cap 34, the inner tube 36, and the second cap 38 partially along their available travel length from engagement with the snap ring 32 toward the closed first end 18 of the damper tube 12. As these components travel along the length of the damper tube 12, hydraulic fluid is forced to flow from a second reservoir through the secondary piston 28, thereby providing a damping effect.

The damping effect provided by the second stage of the jounce cut off assembly 30 is greater than the damping effect provided by the first stage of the jounce cut off assembly 30. In particular, the diameter of the reservoir holding the hydraulic fluid that is being forced through the secondary piston 28 is greater during action of the second stage (e.g., an inner diameter of the damper tube 12 and the second reservoir can be 60 mm) than during action of the first stage (e.g., an inner diameter of the inner tube 36 and the first reservoir can be 46 mm), such that, in the second stage, a greater amount (e.g., volume) of hydraulic fluid must traverse the secondary piston 28 to move the secondary piston 28 a given distance. As a result, as described elsewhere herein, the first stage will be fully compressed before compression of the second stage begins.

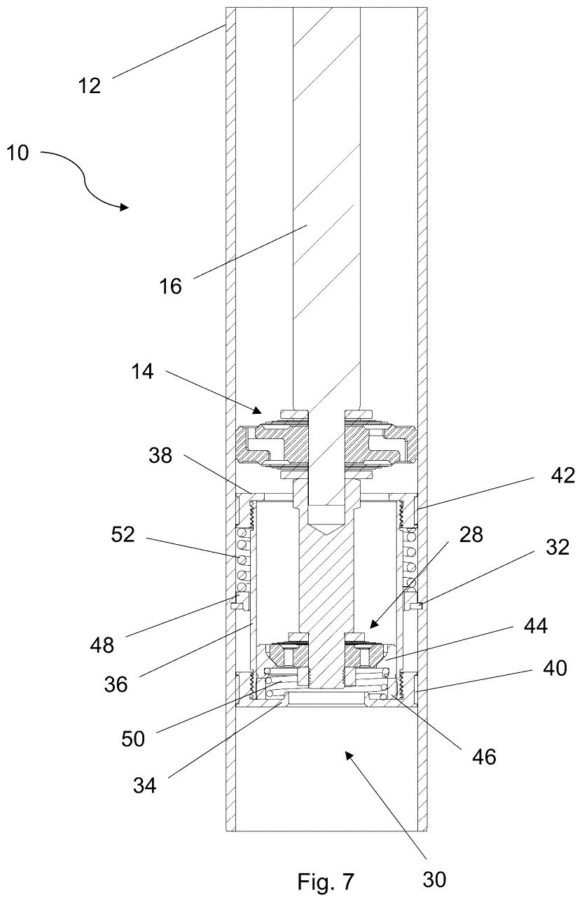

FIG. 7 illustrates the components of FIGS. 2-6 with the first stage of the two-stage jounce cut off assembly 30 fully compressed and the second stage of the two-stage jounce cut off assembly 30 fully compressed. In particular, in the configuration shown in FIG. 7, the secondary piston 28 has pushed the catch ring 44, first cap 34, inner tube 36, and second cap 38 to the end of their available travel length through the damper tube 12 toward the closed first end 18 of the damper tube 12, from engagement with the snap ring 32 to engagement with an outer, second stage spacer or stopper 48 that prevents the second cap 38 from directly colliding at the end of its stroke with the snap ring 32 (in some embodiments, intermediate components, such as a spring, may be present between the second cap 38 and the spacer 48 in this configuration).

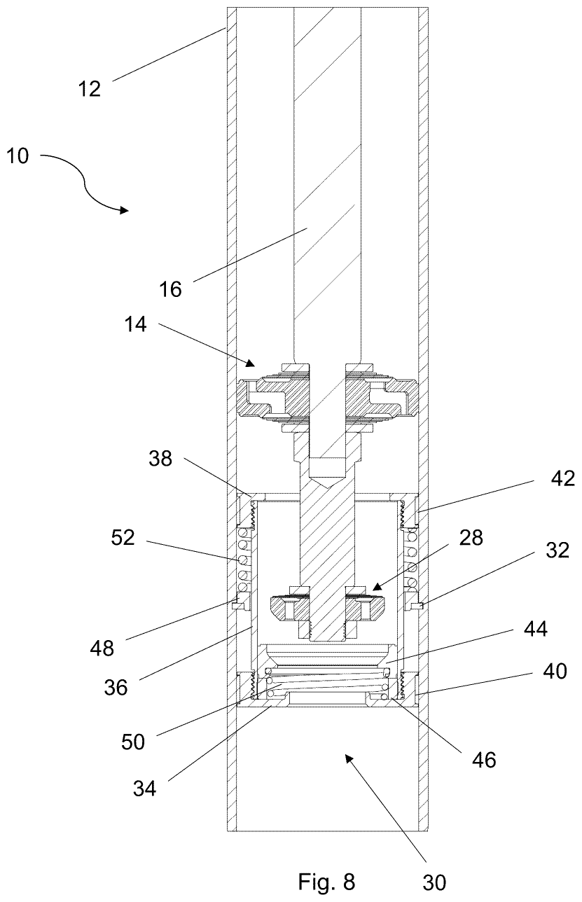

FIG. 8 illustrates the components of FIGS. 2-7 with the first stage of the two-stage jounce cut off assembly 30 fully compressed and the second stage of the two-stage jounce cut off assembly 30 fully compressed as the piston rod 16 begins to extend or rebound (that is, move outward relative to the damper tube 12 or upward in FIG. 8). As illustrated in FIG. 8, the piston rod 16 and the secondary piston 28 coupled thereto may extend or rebound without acting further on the two-stage jounce cut off assembly 30 and the secondary piston 28 separates from the catch ring 44 as it rebounds. Such separation allows the hydraulic fluid to flow relatively freely around the outer periphery of the secondary piston 28, between the secondary piston 28 and the catch ring 44, such as to refill the reservoir(s) from which hydraulic fluid flowed through the secondary piston 28 during retraction. The jounce cut off assembly 30 includes a first stage inner coil spring 50 and a second stage outer coil spring 52 that return the components of the jounce cut off assembly 30 to their original positions shown in FIG. 2 after the piston rod 16 and secondary piston 28 rebound.

In particular, the first stage inner coil spring 50 is positioned and extends between respective surfaces of the catch ring 44 and the first cap 34, such that the coil spring 50 returns the catch ring 44 to its original position relative to the first cap 34, as shown in FIG. 2, when the piston rod 16 and secondary piston 28 rebound. Further, the second stage outer coil spring 52 is positioned and extends between respective surfaces of the spacer 48 and the second cap 38, such that the coil spring 52 returns the first cap 34, inner tube 36, and second cap 38 as a unit to their original position relative to the snap ring 32, as shown in FIG. 2, when the piston rod 16 and secondary piston 28 rebound. The inner and outer coil springs 50 and 52 can provide some negligible resistance to compression of the two-stage jounce cut off assembly, but this resistance is insignificant compared to the resistance and damping effect provided by the viscosity and frictional effects described elsewhere herein.

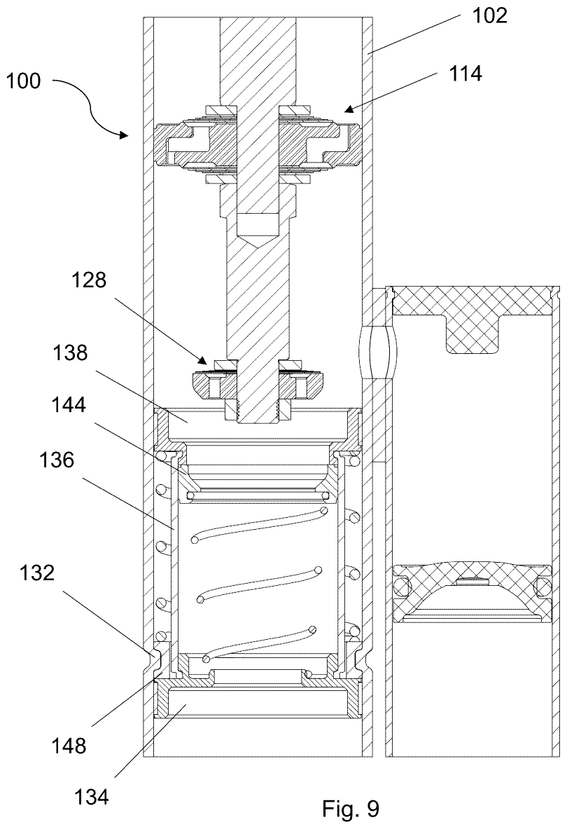

FIG. 9 illustrates another embodiment of a hydraulic vibration damper system 100 with a two-stage jounce cut off assembly in an unengaged and uncompressed configuration, for example as a piston rod begins to retract in a jounce phase of operation (that is, move inward relative to the damper tube or downward in FIG. 9) (in the configuration illustrated in FIG. 9, the piston rod could be stationary or undergoing a rebound phase of operation). The system 100 is similar to the system 10, may include any of the features of system 10, and may be fabricated and used as described for system 10, except as described herein.

As illustrated in FIG. 9, system 100 does not include a snap ring as described with respect to system 10. Instead of using a snap ring as in system 10, the system 100 includes a damper tube 102 that is circumferentially crimped during manufacturing to form an internal raised ridge 132 that operates in a manner similar to that of the snap ring 32 in system 10. In some embodiments, the damper tube 102 may be circumferentially crimped around the entirety of its 360 degree circumference. In other embodiments, the damper tube 102 may be circumferentially crimped around less than the entirety of its 360 degree circumference, such as in interrupted portions of its circumference, such as eight separate, evenly spaced portions extending around the circumference. In particular, the damper system 100 can include an outer, second stage spacer or stopper 148 that is similar to the outer, second stage spacer or stopper 48, and that includes a circumferential groove in an outer surface thereof, into which the internal raised ridge 132 formed by the crimping of the damper tube 102 can extend to lock the spacer 148 in place in the damper tube 102.

As also illustrated in FIG. 9, the system 100 includes a first cap 134, corresponding to the first cap 34, located and locked below the spacer 148 as illustrated in FIG. 9. As further illustrated in FIG. 9, the system 100 includes a second cap 138, corresponding to the second cap 38, located in position above the spacer 148 as illustrated in FIG. 9. The system 100 further includes an inner tube 136, corresponding to the inner tube 36, wherein a first terminal end thereof may be coupled by crimping to the first cap 134 and wherein a second terminal end thereof may be coupled by crimping to the second cap 138. Thus, the first cap 134, the inner tube 136, and the second cap 138 can be rigidly coupled to one another and move as a unit relative to the damper tube 102.

Given the differences between the system 100 and the system 10, the system 100 can be manufactured using a different process than the system 10. For example, a method of assembling the hydraulic vibration damper system 100 may include fabricating the damper tube 102. The method may also include assembling a jounce cut off assembly and then positioning the jounce cut off assembly as a unit inside the damper tube 102. For example, a catch ring 144 can be inserted into the inner tube 136 and the spacer 148 can be mounted on an exterior of the inner tube 136. A first end of the inner tube 136 can then be crimped onto the first cap 134 and a second end of the inner tube 136 can then be crimped onto the second cap 138, thereby locking the catch ring 144 within the inner tube 136 and the spacer 148 on the exterior of the inner tube 136.

The completed assembly of the first cap 134, the inner tube 136, and the second cap 138, together with the catch ring 144, the spacer 148, and other components, such as components corresponding to those described elsewhere herein for system 10, including springs, can then be inserted into the damper tube 102 as a completed unit. The damper tube 102 can then be crimped at a location opposite the groove of the spacer 148, thereby forming the internal raised ridge 132 and locking the spacer 148, and with it the rest of the two-stage jounce cut off assembly, in place in the damper tube 102. While the jounce cut off assembly can be assembled as a unit outside the damper tube 102 and then inserted into and installed within the damper tube 102 as described herein, in other embodiments, the jounce cut off assembly can be assembled inside the damper tube 102, such as in accordance with description elsewhere herein.

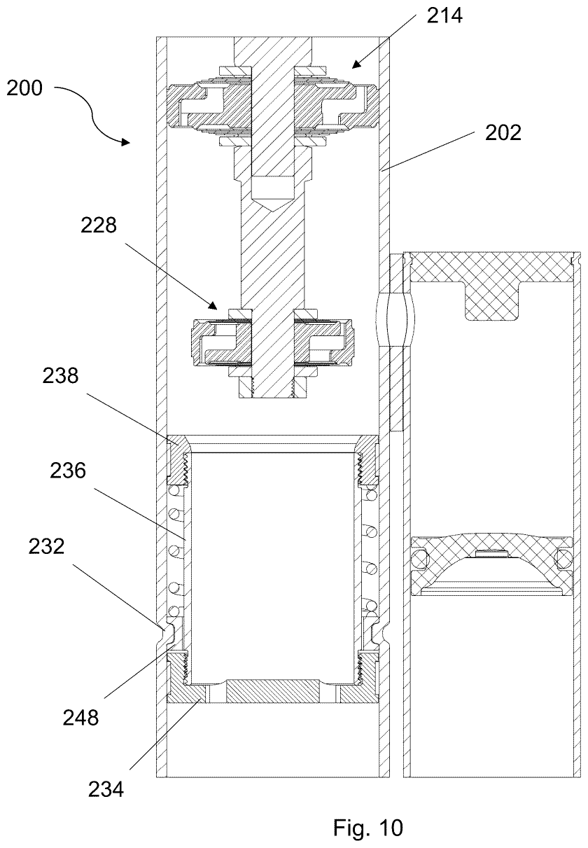

FIG. 10 illustrates another embodiment of a hydraulic vibration damper system 200 with a two-stage jounce cut off assembly in an unengaged and uncompressed configuration, for example, as a piston rod begins to retract in a jounce phase of operation (that is, move inward relative to the damper tube or downward in FIG. 10) (in the configuration illustrated in FIG. 10, the piston rod could be stationary or undergoing a rebound phase of operation). The system 200 is similar to the system 10 and the system 100, may include any of the features of system 10 and/or system 100, and may be fabricated and used as described for system 10 and/or system 100, except as described herein.

As illustrated in FIGS. 1-8, the system 10 includes a primary piston 14 that is bi-directional, in the sense that it provides a damping effect in both an extension and a retraction direction, and a secondary piston 28 that is uni-directional, in the sense that it provides a damping effect in only the retraction direction (compression). As illustrated in FIG. 9, the system 100 includes a primary piston 114 that is bi-directional, in the sense that it provides a damping effect in both an extension and a retraction direction, and a secondary piston 128 that is uni-directional, in the sense that it provides a damping effect in only the retraction direction (compression). As illustrated in FIG. 10, the system 200 includes a primary piston 214 that is bi-directional, in the sense that it provides a damping effect in both an extension and a retraction direction, and a secondary piston 228 that is also bi-directional, in the sense that it provides a damping effect in both the extension and the retraction direction when it is engaged with a jounce cut off assembly.

As illustrated in FIG. 10, system 200 does not include a snap ring as described with respect to system 10, and instead includes a damper tube 202 that is circumferentially crimped during manufacturing to form an internal raised ridge 232 that operates in a manner similar to that of the raised ridge 132 of system 100. In particular, the damper system 200 can include a spacer or stopper 248 that is similar to the spacer 148, and that includes a circumferential groove in an outer surface thereof, into which the internal raised ridge 232 formed by the crimping of the damper tube 202 can extend to lock the spacer 248 in place in the damper tube 202.

As further illustrated in FIG. 10, the damper system 200 includes a first cap 234 located and locked below the spacer 248 as illustrated in FIG. 10. As further illustrated in FIG. 10, the damper system 200 includes a second cap 238 located in position above the spacer 248 as illustrated in FIG. 10. As further illustrated in FIG. 10, the damper system 200 includes an inner tube 236, wherein a first terminal end thereof may be threaded by external threads into counterpart threads formed in an inner surface of the first cap 234 and wherein a second terminal end thereof may be threaded by external threads into counterpart threads formed in an inner surface of the second cap 238. In some alternative embodiments, the inner tube 236 has a first terminal end coupled to an inner surface of the first cap 234 by a first crimped connection and a second terminal end coupled to an inner surface of the second cap 238 by a second crimped connection. Thus, the first cap 234, the inner tube 236, and the second cap 238 can be rigidly coupled to one another and move as a unit relative to the damper tube 202.

Given the differences between the system 200 and the systems 10 and 100, the system 200 can be manufactured using a different process than the systems 10 and 100. For example, a method of assembling the hydraulic vibration damper system 200 may include fabricating the damper tube 202. The method may also include assembling a jounce cut off assembly and positioning the assembled jounce cut off assembly inside the damper tube 202. For example, the spacer 248 can be mounted on an exterior of the inner tube 236. A first end of the inner tube 236 can then be threaded onto the first cap 234 and a second end of the inner tube 236 can then be threaded onto the second cap 238, thereby locking the spacer 248 on the exterior of the inner tube 236. The completed assembly of the first cap 234, the inner tube 236, and the second cap 238, together with the spacer 148 and other components, such as components corresponding to those described elsewhere herein for system 10 and/or 100, including springs, can then be inserted as a unit into the damper tube 202. The damper tube 202 can then be crimped at a location opposite the groove of the spacer 248, thereby forming an internal raised ridge 232 and locking the spacer 248, and with it the rest of the jounce cut off assembly, in place in the damper tube 202.

In operation of the damper system 200, the secondary piston 228 can retract until an outer peripheral surface thereof directly contacts and engages an inner surface of the inner tube 236. Such engagement forces hydraulic fluid to flow through the secondary piston 228 as the secondary piston 228 continues to retract, and such hydraulic fluid flow provides a first additional damping effect that adds to the damping effect provided by the primary piston 214. The secondary piston 228 can continue to retract until it directly contacts and engages the first cap 234. Upon initiation of such engagement, the first cap 234, the inner tube 236, and the second cap 238 move as a unit with the secondary piston 228, and hydraulic fluid continues to flow through the secondary piston 228, as the secondary piston 228 continues to retract. Such hydraulic fluid flow provides a second additional damping effect, which is larger than the first additional damping effect, that adds to the damping effect provided by the primary piston 214.

When the secondary piston 228 stops retracting and begins to extend, the continued engagement of the outer peripheral surface of the secondary piston 228 with the inner surface of the inner tube 236 forces hydraulic fluid to flow through the secondary piston 228 as the secondary piston 228 extends. Such hydraulic fluid flow provides first and second additional damping effects that add to damping effects provided by the primary piston 214 as the secondary piston extends. In the same sense that the secondary piston 228 can provide a first and then a second, larger damping effect during retraction, the secondary piston 228 can provide a first and then a second, smaller damping effect during extension.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise herein. It will also be understood that the description, including disclosed examples and drawings, is intended for purposes of illustration only and is not intended to limit the scope of the present disclosure, its application or uses. Thus, variations that do not depart from the gist of the present disclosure are intended to be within the scope of the present disclosure.

What is claimed is:

1. A hydraulic vibration damper, comprising:
a damper tube having a hollow main body, a first end, and a second end opposite the first end;
a piston rod that extends into the damper tube through the second end of the damper tube;
a primary piston mounted on the piston rod inside the damper tube;
a secondary piston inside the damper tube; and
a two-stage jounce cut off assembly mounted inside the damper tube between the first end of the damper tube and the secondary piston;
wherein the two-stage jounce cut off assembly is configured such that, in a first stage of operation, fluid flows from a first reservoir through the secondary piston and, in a second stage of operation, fluid flows from a second reservoir through the secondary piston;
wherein a diameter of the first reservoir is less than an inner diameter of the hollow main body of the damper tube and a diameter of the second reservoir is equal to the inner diameter of the hollow main body of the damper tube.

2. The hydraulic vibration damper of claim 1 wherein the secondary piston is configured such that hydraulic fluid can flow through the secondary piston during jounce but not during rebound.

3. The hydraulic vibration damper of claim 1 wherein the secondary piston is configured such that hydraulic fluid can flow through the secondary piston during jounce and during rebound.

4. The hydraulic vibration damper of claim 1, wherein the two-stage jounce cut off assembly includes:
an inner tube mounted within the damper tube, wherein in the second stage of operation of the two-stage jounce cut off assembly, the inner tube is configured to translate longitudinally with respect to the damper tube; and
a catch ring mounted within the inner tube, wherein in the first stage of operation of the two-stage jounce cut off assembly, the catch ring is configured to translate longitudinally with respect to the inner tube.

5. The hydraulic vibration damper of claim 1, further comprising:
a circumferential groove extending around the inner surface of the damper tube; and
a snap ring seated within the groove;
wherein the two-stage jounce cut off assembly is mounted directly to, and in direct contact with, the inner surface of the hollow main body of the damper tube at least by the snap ring.

6. The hydraulic vibration damper of claim 1, further comprising:
a circumferential ridge extending around the inner surface of the damper tube;
wherein the jounce cut off assembly is mounted directly to, and in direct contact with, the inner surface of the hollow main body of the damper tube at least by the circumferential ridge.

7. A hydraulic vibration damper, comprising:
a damper tube having a hollow main body, a first end, and a second end opposite to the first end;
a piston rod that extends into the damper tube through the second end of the damper tube;
a primary piston mounted on the piston rod inside the damper tube;
a secondary piston inside the damper tube; and
a two-stage jounce cut off assembly mounted directly to, and in direct contact with, an inner surface of the hollow main body of the damper tube;
wherein the jounce cut off assembly is located between the first end of the damper tube and the secondary piston;
wherein the jounce cut off assembly is configured to increase a hydraulic resistance to movement of the piston rod through the damper tube when the secondary piston engages the jounce cut off assembly.

8. The hydraulic vibration damper of claim 7 wherein the secondary piston is configured such that hydraulic fluid can flow through the secondary piston during jounce but not during rebound.

9. The hydraulic vibration damper of claim 7 wherein the secondary piston is configured such that hydraulic fluid can flow through the secondary piston during jounce and during rebound.

10. The hydraulic vibration damper of claim 7, wherein the two-stage jounce cut off assembly includes:
an inner tube mounted within the damper tube, wherein in a second stage of operation of the two-stage jounce cut off assembly, the inner tube is configured to translate longitudinally with respect to the damper tube; and
a catch ring mounted within the inner tube, wherein in a first stage of operation of the two-stage jounce cut off assembly, the catch ring is configured to translate longitudinally with respect to the inner tube.

11. The hydraulic vibration damper of claim 7, further comprising:
a circumferential groove extending around the inner surface of the damper tube; and
a snap ring seated within the groove;
wherein the two-stage jounce cut off assembly is mounted directly to, and in direct contact with, the inner surface of the hollow main body of the damper tube at least by the snap ring.

12. The hydraulic vibration damper of claim 7, further comprising:
a circumferential ridge extending around the inner surface of the damper tube;
wherein the jounce cut off assembly is mounted directly to, and in direct contact with, the inner surface of the hollow main body of the damper tube at least by the circumferential ridge.

13. The hydraulic vibration damper of claim 7 wherein an outer surface of the two-stage jounce cut off assembly is directly physically sealed against an inner surface of the hollow main body of the damper tube.

14. The hydraulic vibration damper of claim 13 wherein the outer surface of the two-stage jounce cut off assembly is configured to translate along the inner surface of the hollow main body of the damper tube.

15. The hydraulic vibration damper of claim 7, wherein:
the two-stage jounce cut off assembly is configured such that, in a first stage of operation, fluid flows from a first reservoir through the secondary piston and, in a second stage of operation, fluid flows from a second reservoir through the secondary piston;
wherein a diameter of the first reservoir is less than an inner diameter of the hollow main body of the damper tube and a diameter of the second reservoir is equal to the inner diameter of the hollow main body of the damper tube.

16. A method of manufacturing a hydraulic vibration damper, comprising:
fabricating a damper tube having a hollow main body, a first end, and a second end opposite to the first end;
assembling a two-stage jounce cut off assembly outside the damper tube;
inserting the assembled two-stage jounce cut off assembly as a unit into the damper tube;
mounting the two-stage jounce cut off assembly directly to, and in direct contact with, an inner surface of the hollow main body of the damper tube; and
crimping the hollow main body of the damper tube to secure the two-stage jounce cut off assembly inside the damper tube.

17. The method of claim 16, wherein:
the two-stage jounce cut off assembly is configured such that, in a first stage of operation, fluid flows from a first reservoir through a piston and, in a second stage of operation, fluid flows from a second reservoir through the piston; and
a diameter of the first reservoir is less than an inner diameter of the hollow main body of the damper tube and a diameter of the second reservoir is equal to the inner diameter of the hollow main body of the damper tube.

18. The method of claim 17 wherein assembling a two-stage jounce cut off assembly outside the damper tube includes inserting a catch ring into an inner tube and mounting a spacer on an exterior of the inner tube.

19. The method of claim 18 wherein assembling the two-stage jounce cut off assembly outside the damper tube further includes crimping a first end of the inner tube onto the first cap and crimping a second end of the inner tube onto the second cap, thereby locking the catch ring within the inner tube and the spacer on the exterior of the inner tube.
